(19) United States
(12) Patent Application Publication
(10) Pub. No.: US 2026/0235121 A1
(43) Pub. Date: Aug. 13, 2026

(54) Eccentric Screw Pump Device, Pump System, Discharge System and Use

(71) Applicant: Putzmeister Engineering GmbH, Aichtal (DE)

(72) Inventors: Peter BRACK, Muensingen (DE); Jens HAEFNER, Deizisau (DE)

(21) Appl. No.: 19/157,507

(22) PCT Filed: Feb. 9, 2024
(86) PCT No.: PCT/EP2024/053294

§ 371 Date: Aug. 18, 2025

(30) Foreign Application Priority Data
Feb. 16, 2023 (DE) 10 2023 201 352.5

(51) Int. Cl. F04C 2/16; B28B 1/00; B33Y 30/00; F04C 15/00; F04C 15/06

(52) U.S. Cl. CPC F04C 2/16; B28B 1/001; B33Y 30/00; F04C 15/0065; F04C 15/06

(57) ABSTRACT

An eccentric screw pump device has a screw stator, a screw rotor rotatably mounted in the screw stator, and a driveshaft that can be driven in rotation to impress a rotational movement of the screw rotor relative to the screw stator to deliver construction and/or thick material through the screw stator. The driveshaft projects into the screw stator or through the screw stator.

### FIELD OF APPLICATION

The invention relates to an eccentric screw pump device and a pump system having such an eccentric screw pump device. Furthermore, the invention relates to a discharge system for discharging construction and/or thick material, in particular for forming a strand of construction and/or thick material for the 3D printing of a building component. The invention further relates to a use of such an eccentric screw pump device and/or such a pump system and/or such a discharge system.

### OBJECT AND SOLUTION

It is an object of the present invention to devise an eccentric screw pump device, a pump system having such an eccentric screw pump device, a discharge system for discharging construction and/or thick material and also use of such an eccentric screw pump device and/or such a pump system and/or such a discharge system which has improved properties.

This object is achieved by the subjects of the independent patent claims. Preferred embodiments are the subject of the dependent claims.

An eccentric screw pump device according to the invention has a screw stator and a screw rotor. The screw rotor is movably mounted in the screw stator. The screw rotor can be mounted and/or arranged in the screw stator so as to be movable translationally and/or radially. The eccentric screw pump device additionally has a driveshaft that can be driven in rotation to impress a rotational movement of the screw rotor relative to the screw stator to deliver construction and/or thick material through the screw stator. As a result of the impressed rotational movement, it is therefore possible for construction and/or thick material to be conveyed through the screw stator. The driveshaft projects into the screw stator, in particular axially obliquely, or through the screw stator. “Axially obliquely” can relate to an at least partly inclined extent of the driveshaft relative to a central axis of the eccentric screw pump device. The screw stator can overlap the driveshaft at least partly along an axial direction of the eccentric screw pump device. The screw stator and the driveshaft can be arranged to be at least partly nested.

The eccentric screw pump device according to the invention is particularly compact along the axial direction. In particular, an inlet or outlet chamber of the eccentric screw pump device which adjoins the screw rotor in order to supply construction and/or thick stuff to the screw rotor can be designed to be particularly compact along the axial direction, in particular short, in that the driveshaft is at least partly accommodated in the screw stator. A particularly compact, in particular short, inlet or outlet chamber leads to particularly low effort on cleaning during the cleaning of the eccentric screw pump device. In particular, this can make it possible for a region from which the driveshaft projects into the screw stator to be flushed and/or cleanable particularly well, in particularly completely. This makes it possible for at least one region in which construction and/or thick material can remain (dead space) to be reduced. In other words, this makes it possible for a residence time of the construction and/or thick material in the eccentric screw pump device to be short and/or known. Concomitantly, a risk of aging and/or even of adhesion or deposition and/or hardening or caking of the construction and/or thick material in the eccentric screw pump device can be reduced or even completely avoided. Consequently, this makes it possible for a constant and/or known quality of the construction and/or thick material to be ensured. In addition or alternatively, in this way it is made possible for a risk of an increase in stones with excessively large dimensions in the eccentric screw pump device to be reduced or even completely avoided. Overall, a risk of blocking can thus be reduced or even completely avoided. The result is accordingly a particularly reliable and reliably operable eccentric screw pump device.

The construction material can be concrete, in particular fresh concrete. The construction material can be thixotropic and/or semi-solid. The construction material can be dimensionally stable and/or rigid. The construction material can be fast-curing. Additionally or alternatively, the construction material can comprise or be mortar, cement, screed and/or plaster. Further additionally or alternatively, the thick material can be sludge. Further additionally or alternatively, the construction and/or thick material can have a grain size, in particular with a maximum grain size of a minimum of 2 mm, in particular a minimum 8 mm and/or a maximum of 50 mm.

The term “movable in rotation” can be used synonymously for the term “rotationally movable”.

The term “driven in rotation” can be used synonymously for the term “rotationally driven”. Something which can be “driven in rotation” or “designed to be driven in rotation” can be configured to set rotating, in particular by means of a drive device.

The term “space” can be used synonymously for the term “chamber”.

The terms “entry” or “feed” can be used synonymously with one another and with the term “inlet”. Additionally or alternatively, the formulation “to the intake” can be used synonymously with the formulation “to the inlet”.

The terms “exit” or “discharge” can be used synonymously with one another and with the term “outlet”. In addition or alternatively, the formulation “to the displacement” can be used synonymously with the formulation “to the outlet”.

The term “configured” can be used synonymously with the term “designed”.

The terms “comprises” or “has” can be used synonymously with one another.

In the present case, “control” can signify “open-loop control” and/or “closed-loop control”.

In an embodiment of the invention, the driveshaft projects, in particular axially obliquely, into the screw rotor or through the screw rotor. The screw rotor and the driveshaft can therefore be arranged to be nested. In particular, the screw rotor is closed in a manner so as to be construction material-tight and/or thick material-tight. The result is an in particular axially, particularly compactly constructed eccentric screw pump device.

In a further embodiment of the invention, the eccentric screw pump device has an attachment device. The attachment device attaches a drive end of the rotatably driven driveshaft to the screw rotor, in particular cardanically and/or in an angle-tolerant manner. In particular, the attachment device mounts the drive end on the screw rotor, in particular cardanically and/or in an angle-tolerant manner. Thus, the screw rotor can be induced to make an eccentric rotational movement relative to the screw stator.

In a further embodiment of the invention, the screw rotor has a first end face and a second end face axially opposite the first end face. The first end face has an opening, by means of which an axially extended interior of the screw rotor is opened for the partial accommodation of the driveshaft. This benefits a nested arrangement of the screw rotor and driveshaft.

In a further embodiment of the invention, the attachment device is arranged at a distance, in particular an axial distance, from the first end face. The attachment device can be arranged on the second end face and/or within the interior. The result is an axially particularly short eccentric screw pump device.

In a further embodiment of the invention, the second end face has a mounting opening, by means of which the interior of the first end face is opened in the manner of a passage axially opposite the first end face. In particular, the eccentric screw pump device has a first cover, which can be formed in the manner of a cap. In particular, the mounting opening is closed by means of the cover so as to be at least in a construction material-tight and/or thick material-tight. By means of the mounting opening, the ability to be assembled, in particular during the production of a connection between the screw rotor and driveshaft, can be improved. In particular, the mounting opening permits improved accessibility to the interior of the screw rotor.

In a further embodiment of the invention, the eccentric screw pump device has an in particular annular seal device. The seal device is placed on the screw rotor and/or on the driveshaft, in particular circumferentially and/or regularly and/or axially. The seal device can advantageously counteract the penetration of construction and/or thick material into the interior of the screw rotor or even completely prevent such penetration. Such penetration could lead to increased wear of the screw rotor and/or the driveshaft and/or the attachment device, under certain circumstances even to a blockage. The result is therefore a particularly reliable eccentric screw pump device.

Expediently, the eccentric screw pump device—alternatively or additionally—has an in particular annular (other or further) sealing device, which is placed on the screw rotor and on a wall at the eccentric screw pump device, in particular circumferentially and/or radially and/or axially. The wall is fastened to the screw stator and delimits an inlet or outlet chamber of the eccentric screw pump device for the inlet or outlet of construction and/or thick material into the screw stator and out of the screw stator. The (other or further) sealing device can likewise—alternatively or additionally—counteract penetration of construction and/or thick material into the interior of the screw rotor or even completely prevent such penetration.

Expediently, a, in particular the, axially extended interior of the screw rotor is designed for the partial accommodation of the driveshaft and is filled with an incompressible medium, in particular with the liquid. The incompressible medium can in particular be designed such that it experiences substantially no volume change under the action of pressure. By means of the incompressible medium, the sealing device can be supported, in particular axially. This can benefit reliability of the seating device.

In a further embodiment of the invention, the sealing device is designed to be elastically deformable, in particular radially and/or axially, in particular in order to yield to wobbling of the driveshaft relative to the screw rotor associated with the impression of the rotational movement. In particular, the sealing device has an in particular closed-pore foam material or consists of such a foam material. Alternatively or additionally, the sealing device can be formed in the manner of a bellows. The sealing device can be designed as a drive shaft sleeve.

In a further embodiment of the invention, a clear internal diameter of the screw rotor, in particular at the opening of the first end face, is larger than an external diameter of the driveshaft. A ratio of the internal diameter to the external diameter can be a minimum of 1.1 to a maximum of 5.0, in particular a minimum of 1.5 to a maximum of 2.5. In this way, adequate play can be provided for the wobbling of the driveshaft relative to the screw rotor.

In a further embodiment of the invention, the driveshaft has a drive end for drive coupling that can be driven in rotation about a central axis of the eccentric screw pump device. The driveshaft additionally has an output end, in particular the output end, which is arranged opposite to the drive end and which is used for the particular articulated attachment to the screw rotor. The drive end and the output end are connected to each other by means of an articulated shaft of the driveshaft, in particular having at least one cardan joint, and/or by means of an angle-tolerant elastically deformable portion of the driveshaft, in particular having a Hardy disk. The drive end and the output end are connected to each other by means of the articulated shaft and/or the angle-tolerant elastically deformable portion of the driveshaft, in order to compensate for a radial offset between the drive end and/or output end, wherein the radial offset results from an eccentricity of the screw rotor, in particular an own axis of rotation of the screw rotor relative to the screw stator. The articulated shaft can be a portion of the driveshaft.

Expediently, the driveshaft is at least partly, in particular in a portion which projects into the screw rotor and/or the screw stator, set at an angle of a minimum of 0.1° to a maximum of 6°, in particular of a minimum of 1° to a maximum of 3°, with respect to the central axis, in order to bridge the radial offset. At this angle, the drive shaft can project axially obliquely into the screw stator or through the screw stator. The aforementioned angle, together with an eccentricity of the screw rotor relative the screw stator, can necessitate a minimum feasible axial extent of the eccentric screw pump device. This minimum feasible axial extent can be particularly small as a result of the fact that the driveshaft projects axially obliquely into the screw stator and/or the screw rotor.

In a further embodiment of the invention, the rotational movement of the screw rotor relative to the screw stator can be impressed by means of the driveshaft in such a way that when the drive end is driven in rotation about the central axis of the eccentric screw pump device, the screw rotor experiences its own rotation while the screw rotor rotates about the central axis, in particular at a radial distance from the central axis.

In a further embodiment of the invention, the eccentric screw pump device has a drive device for driving the screw rotor by means of the driveshaft. The drive device has an in particular rotational drive connection to a drive end, in particular the drive end, of the driveshaft, such that the drive end can be driven in rotation about a central axis of the eccentric screw pump device by means of the drive device.

A pump system according to the invention has an eccentric screw pump device according to the invention in the sense of the above description. The previously explained advantages of the eccentric screw pump device correspondingly transfer to the pump system according to the invention having such an eccentric screw drive device. The pump system also has a feed pump, wherein the feed pump is designed to deliver construction and/or thick material to the eccentric screw pump device, in particular to the inlet or outlet chamber of the eccentric screw pump device. In particular, the pump system is closed, in particular in a construction material-tight and/or thick material-tight manner from the feed pump as far as the eccentric screw pump device.

A discharge system according to the invention is used to discharge construction and/or thick material, in particular to form a strand of construction and/or thick material for the 3D printing of a building component. The discharge system has a discharge opening, wherein the discharge opening is designed for the discharge of construction and/or thick material, in particular for forming the strand, from the discharge system. The discharge system also has an eccentric screw pump device according to the invention and/or a pump system according to the invention as described previously. The previously indicated advantages of the eccentric screw pump device according to the invention and/or the pump system according to the invention correspondingly transfer to the discharge system according to the invention having such an eccentric screw pump device and/or having such a pump system. The eccentric screw pump device is designed to deliver construction and/or thick material to the discharge opening, in particular to meter construction and/or thick material out of the discharge system.

According to the invention, an eccentric screw pump device according to the invention and/or a pump system according to the invention and/or a discharge system according to the invention, as previously described, are used, in particular for the discharge of construction and/or thick material, in particular for the construction of a building component, in particular for forming a strand of construction and/or thick material for the 3D printing of the building component.

Further advantages and features of the invention can be gathered from the claims and from the following description of preferred exemplary embodiments of the invention, which are illustrated by using the drawings. The same designations relate to the same or similar or functionally identical components.

It goes without saying that the features mentioned above and those still to be explained below can be used not only in the respectively specified combination but also in other combinations or on their own without departing from the scope of the present invention.

### BRIEF DESCRIPTION OF THE DRAWINGS

FIG. 1 is a schematic structure of an embodiment of a discharge system according to the invention having an embodiment of a pump system according to the invention, wherein the pump system has an embodiment of an eccentric screw pump device, which is illustrated in a schematic axial section along its central axis and which is used according to the invention.

FIG. 2 is a schematic structure of a further embodiment of a discharge system according to the invention with a further embodiment of the eccentric screw pump device according to the invention, shown in longitudinal section, in a use according to the invention.

FIG. 3 is a schematic perspective illustration of a further embodiment of the discharge system according to the invention with a further embodiment of an eccentric screw pump device according to the invention in a use according to the invention.

### DETAILED DESCRIPTION OF THE DRAWINGS

A discharge system 100 is used to discharge construction and/or thick material. The discharge system 100 is designed, for example, to discharge construction material and/or thick material to form a strand of construction and/or thick material for the 3D printing of a building component. The strand can be deposited in layers in bead form, in order to build up the building component layer by layer and/or without any formwork. The discharge system 100 has a discharge opening 101. The discharge opening 101 is used to discharge construction and/or thick material from the discharge system 100, for example in order to form the strand of construction and/or thick material. The discharge system 100 additionally has an eccentric screw pump device 1 according to the invention. For example, the eccentric screw pump device 1 is a constituent part of a pump system 50 according to the invention. The eccentric screw pump device 1 is designed to deliver construction and/or thick material to the discharge opening 101, for example in order to meter the discharge of construction and/or thick material out of the discharge system 100.

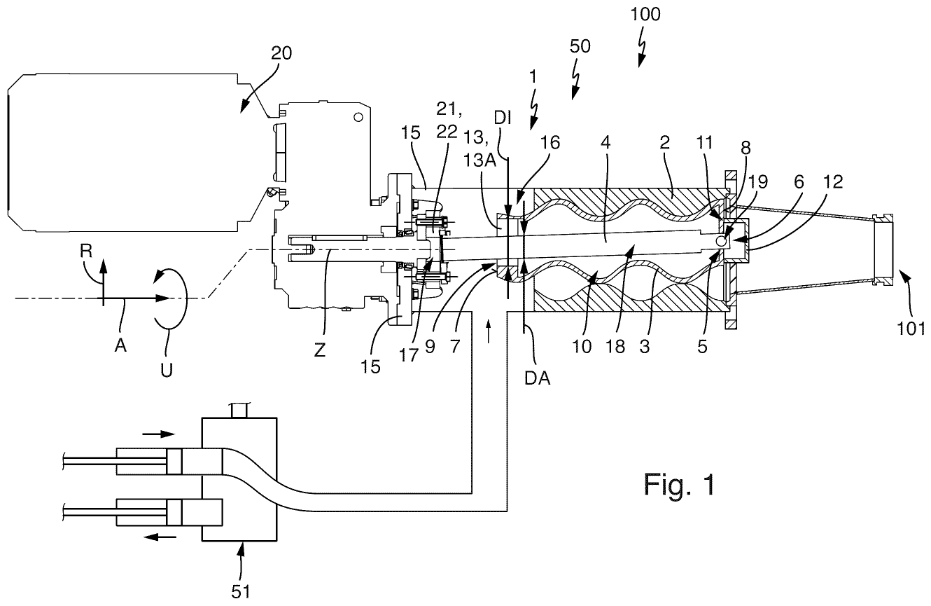

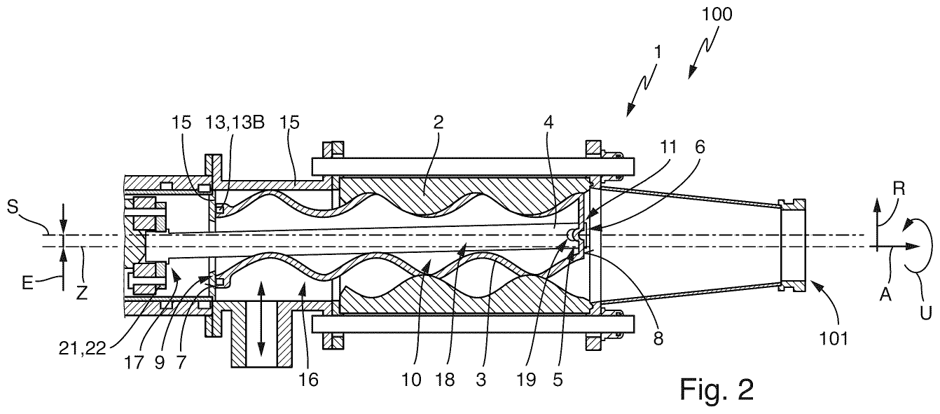

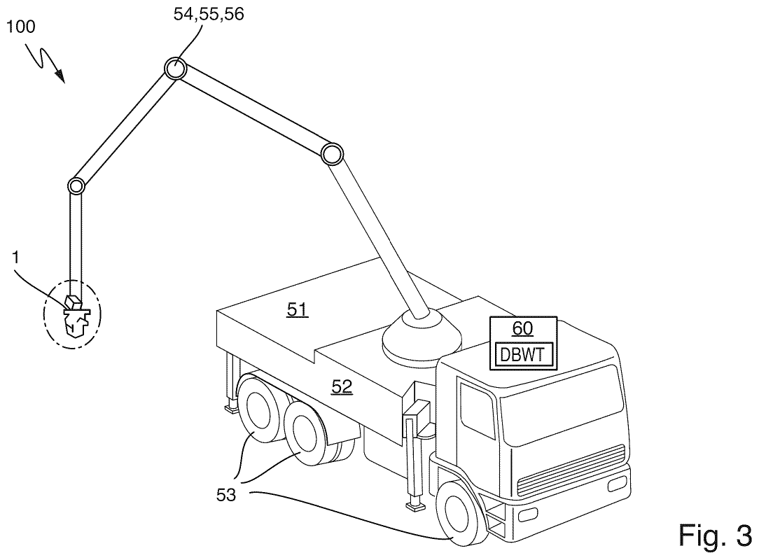

The pump system 50 has, for example, a feed pump 51. The feed pump 51 is designed to deliver construction and/or thick material to the eccentric screw pump device 1. For example, the feed pump 51 is designed to deliver the construction and/or thick material to an inlet or outlet chamber 16 of the eccentric screw pump device 1. For example, the pump system 50 is closed from the feed pump 51 as far as the eccentric screw pump device 1. In the example of FIG. 2, the pump system 50 has no feed pump 51, whereas according to FIGS. 1 and 3 such a feed pump is provided.

The feed pump 51 can have delivery cylinders with variable-volume delivery chambers. To change the volumes of the delivery chambers, in particular in opposite directions, the delivery cylinders can each have an adjustable delivery piston. The feed pump 51 can additionally have an S-shaped pipe switch, in particular an S-pipe, which at one end is connected in a fluid-conducting manner to a pressure nozzle functioning as a feed pump outlet. The pipe switch can be arranged in a supply chamber which can be filled from above with construction and/or thick material for the purpose of storing construction and/or thick material. The pipe switch in the supply chamber can be mounted rotatably at one end on the pressure nozzle. The variable-volume delivery chambers can open into the supply chamber. The pipe switch can be pivoted in the supply chamber relative to the delivery chambers in such a way that it can alternately be connected in a fluid-conducting manner to one of the delivery chambers. In this way, as a result of the counteraction of the pivot team of the pipe switch and a volume change of the delivery chambers, construction and/or thick material located in the supply chamber can alternately be taken in by means of the delivery chambers and pumped to the outside through the pipe switch and via the pressure nozzle. A stirrer mechanism can be arranged in the supply chamber of the feed pump 51. The pressure novel can communicate in a construction material conducting and/or thick material conducting manner to the inlet or outlet chamber 16 of the eccentric screw pump device 1.

FIGS. 1 to 3 show the eccentric screw pump device 1 and/or the pump system 50 and/or the discharge system 100 in use. According to this use, the eccentric screw pump device 1 and/or the pump system 50 and/or the discharge system 100 are used to discharge construction and/or thick material. In particular, the eccentric screw pump device 1 and/or the pump system 50 and/or the discharge system 100 are used to form a building component. For example, the eccentric screw pump device 1 and/or the pump system 50 and/or the discharge system 100 are used to form a strand of construction and/or thick material for the print 3D printing, i.e. the additive fabrication, of the building component.

The eccentric screw pump device 1 has a screw stator 2. The screw stator 2 can have an elastic material or consist of such an elastic material. In addition, the eccentric screw pump device 1 has a screw rotor 3, which is movably mounted in the screw stator 2. The screw rotor 3 can have a metallic material or consist of such a metallic material. The metallic material can have a metal or a plurality of metals or consist of a metal or of a plurality of metals. The screw rotor 3 can have a coating on the outside which, for example, is produced by means of a thermal coating process. For example, the coating can be produced by means of flame spraying and/or by means of plasma-powder application welding, in particular by means of an “enhanced plasma transferred arc” (ePTA) process. For example, the material of the screw rotor 3 can be more ductile on the inside than on the outside and/or harder on the outside than on the inside. Alternatively or additionally, the screw rotor 3 can have a composite material or consist of a composite material. The screw rotor 3 can have a ceramic coating on the outside.

Furthermore, the eccentric screw pump device 1 has a driveshaft 4 that can be driven in rotation. The driveshaft 4 serves primarily to impress a rotational movement of the screw rotor 3 relative to the screw stator 2. As a result of the impressed rotational movement of the screw rotor 3 relative to the screw stator 2, the construction and/or thick material can be delivered through the screw stator 2. The driveshaft 4 projects into the screw stator 2 or through the screw stator 2. For example, the driveshaft 4 projects axially obliquely into the screw stator 2 or through the screw stator 2. “Axially obliquely” can mean that the driveshaft 4 is at least partly inclined or set with respect to a central axis Z of the eccentric screw pump device 1. For example, the driveshaft 4 is at least partly set at an angle of a minimum of 0.1° or at a maximum of 6°, in particular of a minimum of 1° to a maximum of 3° with respect to the central axis Z, in order to bridge a radial offset between the screw rotor 3 and the screw stator 2. At this angle, the driveshaft 4 can project axially obliquely into the screw stator 2. The driveshaft 4 can additionally project, in particular axially obliquely, into the screw stator 2. According to the embodiments shown, the driveshaft 4 projects axially obliquely through the screw rotor 3. In particular, the driveshaft 4 projects into an overlap region, in which the screw stator 2 and the screw rotor 3 overlap one another in a nested manner along the central axis Z. Rotor 3 is closed, for example at least in a construction material-tight and/or thick material-tight manner. As a result of the aforesaid closure of the screw rotor 3, a pressure difference resulting from the impressed rotational movement between two ends of the screw rotor 2 located opposite each other along the central axis Z can be produced.

The eccentric screw pump device 1 in the present case has an attachment device 5. The driveshaft 4 has an output end 6. The output end 6 is attached to the screw rotor 3 by means of the attachment device 5. In particular, the attachment device 5 mounts the output end 6 of the rotationally driven driveshaft 4 on the screw rotor 3. The output end 6 can be attached to the screw rotor 3 cardanically or in an angle-tolerant manner by means of the attachment device 5.

The screw rotor 3 has a first end face 7. The screw rotor 3 additionally has a second end face 8, which is arranged axially opposite the first end face 7. Axially refers to an axial direction A along which the central axis Z extends, in particular in parallel. A radial direction R extends at right angles to the axial direction A. A circumferential direction U extends around the central axis Z, in particular within a plane at right angles to the central axis Z. The end faces 7, 8 can be arranged at mutually opposite front ends of the screw rotor 3 and/or form such front ends. The first end face 7 has an opening 9. The screw rotor 3 is, for example, at least partly hollow. The screw rotor 3 in the present case has an axially extended interior 10, which is used to at least partly accommodate the driveshaft 4. The interior 10 is opened by means of the opening 9 of the first end face 7. The attachment device 5 in the present case is arranged at a distance from the first end face 7. This distance between the attachment device 5 and the first and face 7 can also be an axial distance. The attachment device 5 in the present case is arranged on the second end face 8 within the interior 10.

The second end face 8 of the screw rotor 3, opposite the first end phase 7, has a mounting opening 11. By means of this mounting opening 11, the interior 10 of the first end face 7 is opened in the manner of a passage opposite to the first end face 7. According to the embodiment of FIG. 1, the eccentric screw pump device 1 has a cover 12. The cover 12 is like a cap and/or like a plug. The mounting opening 11 is closed at least in a construction material-tight and/or thick material-tight manner by means of the cap-like cover 12.

According to the embodiment of FIG. 1, the eccentric screw pump device 1 has a sealing device 13, 13a. The sealing device 13, 13a is annular. The sealing device 13, 13a is applied to the screw rotor 3 and to the driveshaft 4. The sealing device 13, 13a is additionally applied to the driveshaft 4. The sealing device 13, 13a is applied circumferentially and radially to the screw rotor 3 and the driveshaft 4. The sealing device 13, 13a is arranged in a radial gap between the screw rotor 3 and the driveshaft 4. Alternatively or additionally, the sealing device 13, 13a can be applied axially to the screw rotor 3 and/or to the driveshaft 4.

In the embodiment according to FIG. 2, the eccentric screw pump device 1 has another sealing device 13, 13b. The other sealing device 13, 13b is, for example, annular. The eccentric screw pump device 1 has a wall 15. The wall 15 is fastened to the screw stator 2. The wall 15 delimits an inlet or outlet chamber 16 of the eccentric screw pump device 1 relative to the inlet or outlet of construction and/or thick material into the screw stator 2 or out of the screw stator 2. The driveshaft 4 is partly arranged within the inlet or outlet chamber 16. The other sealing device 13, 13b is applied to the screw rotor 3 and to the wall 15. For example, the other sealing device 13, 13b is applied axially to the screw rotor 3 and to the wall 15. The other sealing device 13, 13b in the present case is applied axially between the wall 15 and the screw rotor 3. Alternatively or additionally, the other sealing device 13, 13b can be applied radially and/or circumferentially to the screw rotor 3 and to the wall 15.

The interior 10 of the screw rotor 3, which is axially extended and designed to accommodate at least one region of the driveshaft 4 is, for example, filled with an incompressible medium. The incompressible medium preferably experiences no pressure-dependent volume change. The incompressible medium can therefore, for example, be compressed barely or not at all. Preferably, the incompressible medium is a liquid. By means of the incompressible medium, an abutment or a support of the sealing device(s) 13, 13a, 13b with respect to the inlet or outlet chamber 16 can be provided.

The sealing device 13, i.e. the sealing device 13a and/or the other sealing device 13b, is radially and/or axially elastically deformable. The sealing device 13 is elastically deformable in order to yield to wobbling of the driveshaft 4 relative to the screw rotor 3 and/or relative to the wall 15. The sealing device 13 is elastically deformable. The sealing device 13 can have a foam material or consist of such a foam material. The foam material can be formed with closed pores. Alternatively or additionally, the sealing device 13 can be formed in the manner of a bellows. For example, the sealing device 13 is designed as a sealing sleeve, in particular as a drive shaft sleeve. Alternatively or additionally, the sealing device can have an elastomer will consist of an elastomer. The sealing device 13 can have a rubber material or consist of a rubber material.

The screw rotor 3 has an internal diameter DI. The internal diameter DI can be a clear internal diameter DI. The internal diameter DI of the screw rotor 3 is preferably present on the opening 9 of the first end face 7. The internal diameter DI is larger than external diameter DA of the driveshaft 4. Accordingly, a radial annular gap can be formed between the opening 9 and the driveshaft 4. Because of the inclination of the driveshaft 4 relative to the central axis Z, the annular gap can have a radial extent along the circumferential direction U that changes when the rotational movement is impressed. A ratio of the internal diameter DI to the external diameter DA is preferably a minimum of 1.1 to a maximum of 5.0. In the present case, the ratio of the internal diameter DI to the external diameter DA is a minimum of 1.5 to a maximum of 2.5.

The driveshaft 4 has a drive end 17, which is arranged opposite the output end 6 of the driveshaft 4. The drive end 17 can, for example, be driven in rotation about the central axis Z of the eccentric screw pump device 1. The drive end 17 is used for drive coupling of the driveshaft 4. In the present case, the eccentric screw pump device 1 has a drive device 20, which is configured to drive the screw rotor 3 by means of the driveshaft 4. For the purpose of drive coupling, in the present case the drive end 17 of the driveshaft 4 has a rotational drive connection to the drive device 20.

The output end 6 is used for a preferably articulated attachment to the screw rotor 3, in particular by means of the attachment device 5. An articulated shaft 18 of the driveshaft 4 is arranged between the drive end 17 and the output end 6. The articulated shaft 18 of the driveshaft 4 has at least one cardan joint 19, in the present case exactly one cardan joint 19. The cardan joint 19 is arranged on the attachment device 5. Alternatively or additionally, the driveshaft 4 has an angle-tolerant elastically deformable portion 21. In the present case, there is exactly one such angle-tolerant elastically deformable portion 21 which, in the embodiments shown, has a Hardy disk 22. It goes without saying that as compared with the embodiments shown, the Hardy disk 22 can be replaced by a second cardan joint 19 or the cardan joint 19 can be replaced by a second Hardy disk 22. The articulated shaft 18 and/or the angle-tolerant elastically deformable portion 21 of the driveshaft 4 are configured to compensate for a radial offset between the drive end 17 and output end 6. The radial offset results from an eccentricity E of the screw rotor 3 relative to the screw stator 2. The eccentricity E relates in particular to the radial offset between an own axis of rotation S of the screw rotor 3 relative to the screw stator 2.

The rotational movement of the screw rotor 3 relative to the screw stator 2 can be impressed by means of the driveshaft 4 in such a way that when the drive end 17 is driven in rotation about the central axis Z, the screw rotor 3 experiences its own rotation about its own axis of rotation S, while the screw rotor 3 rotates about the central axis Z. Therefore, when the drive end 17 is driven in rotation, the screw rotor 3 rotates firstly about its own axis of rotation S and secondly rotates about the central axis Z, in particular eccentrically at a radial distance from the central axis Z. The drive device 20 can have a drive connection to the drive end 17 of the driveshaft 4 in such a way that the drive end 17 can be driven in rotation about the central axis Z of the eccentric screw pump device 1 by means of the drive device 20. In other words, because of its rotary drive, the screw rotor 3 can rotate about itself. As a result of a shaping of the screw stator 2 and the screw rotor 3, the screw rotor 3 can execute a hyper-cycloidal movement and deliver the construction and/or thick material by means of displacement by means of delivery spaces or delivery chambers which are formed between the screw stator 2 and the screw rotor 3.

According to FIG. 3, the discharge system 100 has a movement device 54. The movement device 54 is, for example, designed to move, in particular to adjust, the eccentric screw pump device 1 and/or the discharge opening 101 preferably arranged thereon. For example, the eccentric screw pump device 1 and/or the discharge opening 101 can be moved automatically and/or translationally and/or rotationally by means of the movement device 54, in particular along and/or around three spatial axes of a three-dimensional cartesian coordinate system. The discharge opening 101 can be arranged on a pressure. Preferably, the eccentric screw pump device 1 and/or the discharge opening 101 can be moved by means of the movement device 54 relative to the feed pump 51, in particular during the delivery of construction and/or thick material and/or during the discharge and/or during the formation of construction material. For example, by means of the feed pump 51, construction and/or thick material can be at least partly, in particular completely, delivered along the movement direction 54. The movement device 54 in the present case has an arm 55, in particular a distributor mast 56. The arm 55 can be designed with multiple axles, in particular multiple joints. In particular, the movement device 54 is the arm 55. The eccentric screw pump device 1 and/or the discharge device 101 can be arranged and/or fastened, in particular directly, in the area of a tip of the arm 55, in particular to a tip of the distributor mast 56. The arm tip and/or mast tip can be arranged at a free end of the arm 55 or of the distributor mast 56, respectively.

For example, the eccentric screw pump device 1, the feed pump 51 and/or the movement device 54 are controllable, for example electrically controllable, in particular independently of one another. The discharge system 100 can have an in particular electrical or electronic control device 60 for this purpose, in particular in the form of a computer. The control device 60 is configured for the in particular automatic and/or electrical control of the eccentric screw pump device 1 for delivering construction and/or thick material, the feed pump 51 for delivering construction and/or thick material and/or the movement device 54 for moving the eccentric screw pump device 1 and/or the discharge opening 101. In particular, the control device 60 is designed to control the aforementioned components as a function of data DBWT, in particular a construction or design plan of the building component to be printed. The data DBWT can be stored in a memory of the control device 60. For example, the control device 60 is designed to control the drive device 20 of the eccentric screw pump device 1. The control device 60 can be designed to control a drive motor of the feed pump 51. The eccentric screw pump device 1, the feed pump 51 and/or the movement device 54 can be designed, in particular in each case, to interact with the control device 60. The printhead having the discharge opening 101 can likewise be controlled by means of the control device 60 interaction with the components above.

For example, the discharge system 100 has a chassis 53. The discharge system 100 can be an automatic construction material pump 52 which has the chassis 53. The chassis 53 carries the eccentric screw pump device 1, the feed pump 51, the discharge opening 101, the movement device 54 and/or the control device 60, in particular directly.

1.-15. (canceled)

16. An eccentric screw pump device, comprising:
a screw stator;
a screw rotor movably supported in the screw stator; and
a driveshaft that is drivable in rotation for impressing a rotational movement of the screw rotor relative to the screw stator to deliver construction and/or thick material through the screw stator,
wherein the driveshaft projects into the screw stator or through the screw stator.

17. The eccentric screw pump device according to claim 16,
wherein the driveshaft projects, axially obliquely, into the screw stator or through the screw stator.

18. The eccentric screw pump device according to claim 17,
wherein the screw rotor is closed at least in a construction material-tight and/or thick material-tight manner.

19. The eccentric screw pump device according to claim 16, further comprising:
an attachment device,
wherein the attachment device attaches an output end of the rotationally driven driveshaft to the screw rotor.

20. The eccentric screw pump device according to claim 19, wherein
the attachment device attaches the output end of the rotationally driven driveshaft to the screw rotor cardanically and/or in an angle-tolerant manner, and supports the same on the screw rotor.

21. The eccentric screw pump device according to claim 16, wherein
the screw rotor has a first end face and a second end face axially opposite the first end face, and
the first end face has an opening by which an axially extended interior of the screw rotor is opened to partly accommodate the driveshaft.

22. The eccentric screw pump device according to claim 16, further comprising:
an attachment device, wherein the attachment device attaches an output end of the rotationally driven driveshaft to the screw rotor,
the screw rotor has a first end face and a second end face axially opposite the first end face, and
the first end face has an opening by which an axially extended interior of the screw rotor is opened to partly accommodate the driveshaft,
wherein the attachment device is arranged at an axial distance from the first end face, on the second end face and/or within the interior.

23. The eccentric screw pump device according to claim 22,
wherein the second end face has a mounting opening, by which the interior is opened in the manner of a passage axially opposite the first end face,
wherein the eccentric screw pump device has a cap-shaped cover, by which the mounting opening is closed at least in a construction material-tight and/or thick material-tight manner.

24. The eccentric screw pump device according to claim 16, further comprising:
an annular sealing device which is applied to the screw rotor and/or to the driveshaft, circumferentially and/or radially and/or axially, and/or
wherein an axially extended interior of the screw rotor is configured to partly accommodate the driveshaft and is filled with an incompressible medium.

25. The eccentric screw pump device according to claim 24, wherein
the sealing device is elastically deformable, radially and/or axially, in order to yield to wobbling of the driveshaft relative to the screw rotor associated with the impression of the rotational movement, and
the sealing device has a closed-pore foam material and/or is formed in the manner of a bellows.

26. The eccentric screw pump device according to claim 21, wherein
a clear internal diameter (DI) of the screw rotor, at the opening of the first end face, is larger than an external diameter (DA) of the driveshaft, and
a ratio of the internal diameter (DI) to the external diameter (DA) is a minimum of 1.1 to a maximum of 5.0.

27. The eccentric screw pump device according to claim 16, wherein
the driveshaft has a drive end which is drivable in rotation about a central axis (Z) of the eccentric screw pump device for drive coupling and an output end, opposite the drive end, for articulated attachment to the screw rotor, and
the drive end and the output end are connected to each other via an articulated shaft of the driveshaft having at least one cardan joint, and/or by an angle-tolerant elastically deformable portion of the driveshaft having a Hardy disk, in order to compensate for a radial offset between the drive end and the output end, wherein the radial offset results from an eccentricity (E) of the screw rotor relative to the screw stator.

28. The eccentric screw pump device according to claim 27, wherein
the rotational movement of the screw rotor relative to the screw stator can be impressed by way of the driveshaft such that when the drive end is driven in rotation about the central axis (Z) of the eccentric screw pump device, the screw rotor experiences its own rotation, while the screw rotor rotates about the central axis (Z), eccentrically at a radial distance from the central axis (Z).

29. The eccentric screw pump device according to claim 16, further comprising:
a drive device to drive the screw rotor via the driveshaft,
wherein the drive device has a drive connection to a drive end of the driveshaft such that the drive end is drivable in rotation about a central axis (Z) of the eccentric screw pump device via the drive device.

30. A pump system, comprising:
an eccentric screw pump device according to claim 16;
a feed pump, wherein the feed pump is configured to deliver construction and/or thick material to an inlet or outlet chamber of the eccentric screw pump device,
wherein the pump system is closed from the feed pump as far as the eccentric screw pump device.

31. A discharge system for discharging construction and/or thick material for forming a strand of construction and/or thick material for 3D printing of a building component, the discharge system comprising:
a discharge opening, wherein the discharge opening is designed to discharge construction and/or thick material, for forming the strand from the discharge system; and
a pump system according to claim 30,
wherein the eccentric screw pump device is designed to deliver construction and/or thick material to the discharge opening, to meter the discharge of construction and/or thick material from the discharge system.

32. A method of operating a discharge system to discharge construction and/or thick material for construction of a building component for forming a strand of construction and/or thick material for 3D printing of the building component utilizing the eccentric screw pump device according to claim 16.
